(19) United States
(12) Patent Application Publication
(10) Pub. No.: US 2026/0096694 A1
(43) Pub. Date: Apr. 9, 2026

(54) METHODS AND DEVICES FOR PROCESSING AND STORING FOOD

(71) Applicant: Tegriware LLC, Holland, MI (US)

(72) Inventor: Devon Hudson, Holland, MI (US)

(21) Appl. No.: 19/416,770

(22) Filed: Dec. 11, 2025

Related U.S. Application Data
(63) Continuation of application No. PCT/US2024/033416, filed on Jun. 11, 2024.
(60) Provisional application No. 63/507,617, filed on Jun. 12, 2023.
(60) Provisional application No. 63/642,376, filed on May 3, 2024.

(51) Int. Cl. A47J 47/08; A47J 47/00

(52) U.S. Cl. CPC A47J 47/08; A47J 47/005

(57) ABSTRACT

Methods and devices for processing and storing food have been described herein. A device may include an upper portion defining an aperture, the upper portion being rotatably and reversibly coupled to a storage portion. A device may include a plurality of compartments either defined by the storage portion or contained by the storage portion, wherein the upper portion includes a cutting surface, wherein the upper portion is configured to rotate with respect to the storage portion substantially aligning the aperture with a first compartment of the plurality of compartments.

### CROSS-REFERENCE TO RELATED APPLICATIONS

This application is a continuation of International Patent Application PCT/US2024/033416, filed Jun. 11, 2024 and published as WO 2024/258855, which claims the priority benefit of U.S. Provisional Application No. 63/507,617, filed Jun. 12, 2023, and U.S. Provisional Application No. 63/642,376, filed May 3, 2024, the disclosure of each of which is herein incorporated by reference in its entirety.

### TECHNICAL FIELD

This disclosure relates generally to the field of processing and storing food, and more specifically to the field of processing and organizing into one or more storage compartments. Described herein are devices and methods for processing and storing food.

### BACKGROUND

Processing and storing food can be challenging and can lead to messy clean-ups. A typical process may involve a cutting board for the processing of food (e.g., vegetables, meat, etc.). Processed food may then be organized into containers. For example, a chop salad with six different vegetables may require a cutting board and six individual bowls for preparation. As such, food preparation and many other similar processes may produce excessive dishes and utensils to be cleaned afterwards. Additionally, the organization of processed food from the cutting board to the individual compartments may be cumbersome and may result in wasted processed food due to mishandling.

Accordingly, there exists a need to develop new devices and systems that address these long-known issues. Devices may need to be easily used, simple, and ergonomic.

### SUMMARY

In some aspects, the techniques described herein relate to a device for processing and storing food, including: a storage portion; an upper portion defining an aperture, the upper portion being configured to be rotatably and reversibly couplable to the storage portion; and a plurality of compartments either defined by the storage portion or contained by the storage portion, wherein the upper portion includes a cutting surface, wherein the upper portion is configured to rotate with respect to the storage portion to substantially align the aperture with a first compartment of the plurality of compartments.

In some aspects, the techniques described herein relate to a device for processing and storing food, including: a storage portion defining at least a first compartment; and an upper portion defining an aperture, wherein a bottom surface of the upper portion is configured to be rotatably and reversibly coupled to the storage portion, wherein the upper portion is configured to be rotated relative to the storage portion, wherein the upper portion includes a cutting surface, opposite the bottom surface.

In some aspects, the techniques described herein relate to a method of using a device for processing and storing food, including: processing food on a cutting surface of an upper portion of the device, the upper portion being rotatably and reversibly coupled to a storage portion of the device; rotating the upper portion of the device with respect to the storage portion of the device to align an aperture defined by the upper portion of the device with a first compartment of one or more compartments either defined by or contained within the storage portion of the device; and transferring at least a portion of the processed food on the cutting surface of the upper portion of the device through the aperture defined by the upper portion of the device and into the first compartment of the one or more compartments.

### BRIEF DESCRIPTION OF THE DRAWINGS

The foregoing is a summary, and thus, necessarily limited in detail. The above-mentioned aspects, as well as other aspects, features, and advantages of the present technology are described below in connection with various embodiments, with reference made to the accompanying drawings.

FIG. 1 illustrates a perspective view of an embodiment of a device for processing and storing food.

FIG. 2 illustrates a perspective view of an embodiment of an upper portion of a device for processing and storing food.

FIG. 3 illustrates a normal view of an embodiment of an upper portion of a device for processing and storing food.

FIG. 4 illustrates a normal view of an embodiment of an upper portion of a device for processing and storing food.

FIG. 5A illustrates a normal view of an embodiment of a storage portion of a device for processing and storing food.

FIG. 5B illustrates a normal view of an embodiment of a storage portion of a device for processing and storing food.

FIG. 6A illustrates a cross-sectional view of layers of an embodiment of an upper portion of a device for processing and storing food.

FIG. 6B illustrates a cross-sectional view of layers of an embodiment of an upper portion of a device for processing and storing food.

FIG. 7 illustrates a perspective view of an embodiment of a device for processing and storing food with removable compartments within a storage portion of the device.

FIG. 8 illustrates a perspective view of an embodiment of a device for processing and storing food.

FIG. 9 illustrates a cross-section view of an embodiment of a device for processing and storing food.

FIG. 10 illustrates a normal view of an upper portion of an embodiment of a device for processing and storing food illustrating the size of an aperture with respect to the upper portion.

FIG. 11 illustrates a normal view of an upper portion of an embodiment of a device for processing and storing food illustrating the size of an aperture with respect to the upper portion.

FIG. 12 illustrates a perspective view of a cross-section of an embodiment of a device for processing and storing food with a lid.

FIG. 13 illustrates a perspective view of an embodiment of a device for processing and storing food without a lid.

FIG. 14 illustrates a bottom view of a storage portion of a device embodiment, including a plurality of ribs coupling the compartments of the storage portion together.

The illustrated embodiments are merely examples and are not intended to limit the disclosure. The schematics are drawn to illustrate features and concepts and are not necessarily drawn to scale.

### DETAILED DESCRIPTION

The foregoing is a summary, and thus, necessarily limited in detail. The above-mentioned aspects, as well as other aspects, features, and advantages of the present technology will now be described in connection with various embodiments. The inclusion of the following embodiments is not intended to limit the disclosure to these embodiments, but rather to enable any person skilled in the art to make and use the contemplated invention(s). Other embodiments may be utilized, and modifications may be made without departing from the spirit or scope of the subject matter presented herein. Aspects of the disclosure, as described and illustrated herein, can be arranged, combined, modified, and designed in a variety of different formulations, all of which are explicitly contemplated and form part of this disclosure.

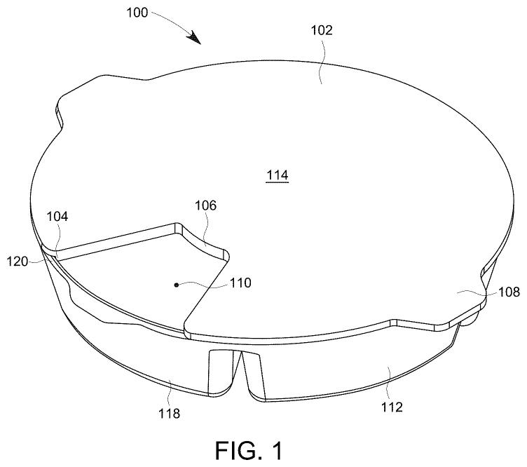

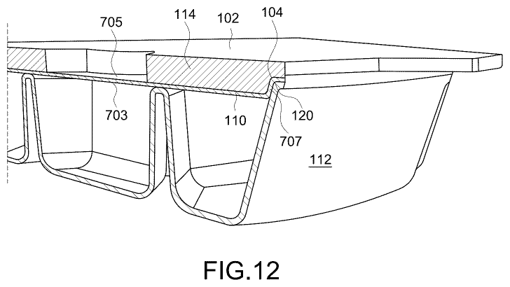

FIG. 1 illustrates an embodiment of a device 100 for processing and storing food. The device 100 includes a storage portion 112, an upper portion 114, and optionally, a lid 110. The upper portion 114 may include one or more handles 108 (optionally an extension of the cutting surface or a separate extension) and a cutting surface 102. The upper portion 114 may include a rigid material suitable for processing food upon (e.g., wood, plastic, granite, etc.). The storage portion 112 may include one or more compartments 118 (e.g., one compartment, one or more compartments, a plurality of compartments, etc.). The storage portion 112 may include a rim 120 that interfaces with a shelf 104 of the upper portion 114. The upper portion 114 may rotate with respect to the storage portion 112 upon the interface of the rim 120 and the shelf 104. Further, the upper portion 114 may define one or more apertures 106. The upper portion 114, the lid 110, and the storage portion 112 are reversibly coupled together. The lid 110 may be reversibly positionable as illustrated between the upper portion 114 and the storage portion 112. When the lid 110 is placed or coupled to the storage portion 112, as illustrated in FIGS. 1 and 12, the lid 110 blocks communication between the aperture 106 and the one or more compartments 118 of the storage portion 112. Blocking communication between the aperture 106 and the one or more compartments 118 of the storage portion 112 secures contents within the one or more compartments 118.

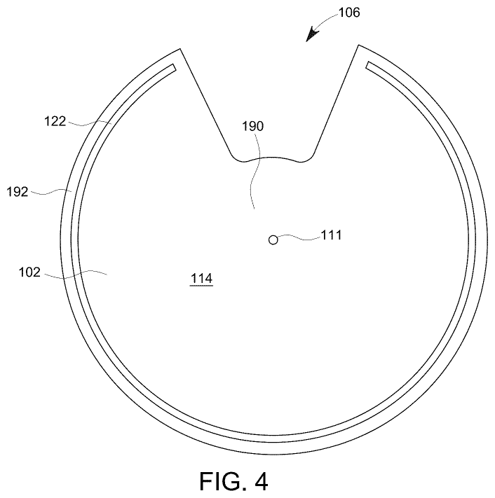

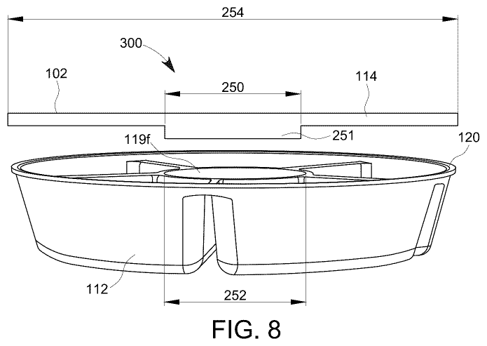

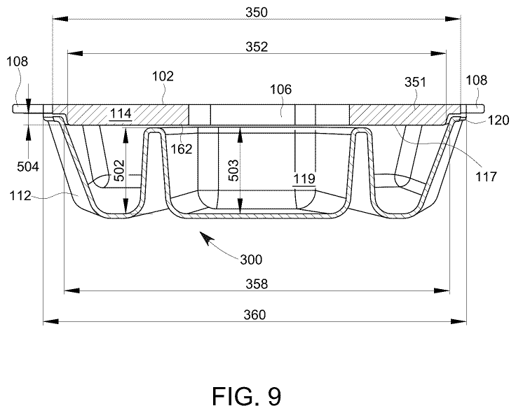

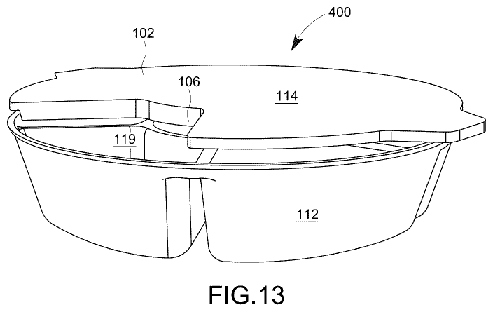

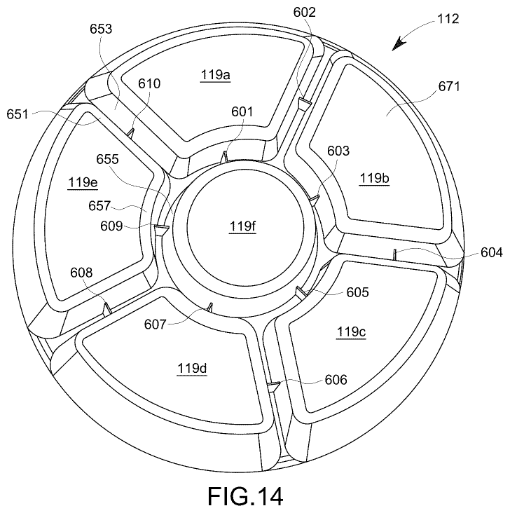

FIGS. 8, 9, and 13 illustrate the upper portion 114 including a cutting surface 102 opposite a bottom surface 117 (shown in FIG. 9). FIGS. 9 and 13 show the upper portion 114 operatively coupled to the storage portion 112. When coupled to the storage portion 112, the cutting surface 102 of the upper portion 114 is on the opposite side of the upper portion 114 from the storage portion 112. The cutting surface 102 may be a substantially flat surface well-suited for processing food upon (e.g., chopping, cutting, mashing, etc.). The cutting surface 102 may utilize beneficial features for the intended processing. For example, FIG. 4 illustrates a juice ring 122 on the cutting surface 102 of the upper portion 114. The juice ring 122 may be used with any upper portion described herein. The juice ring 122 may be a recessed section in the cutting surface 102 or protruding from the cutting surface 102. Whether recessed into the cutting surface 102 or protruded from the cutting surface 102, the juice ring 122 divides the processing portion 190 of the cutting surface 102 from the outer portion 192 or perimeter or ring of the cutting surface 102. As such, liquids (e.g., juices, etc.) produced by processing food on processing portion 190 of the cutting surface 102 are separated from the outer portion 192 of the cutting surface 102 by the juice ring 122. If liquids from the processing portion 190 of the cutting surface 102 are not allowed to access the outer portion 192 of the cutting surface 102, then spilling of the liquids is less likely.

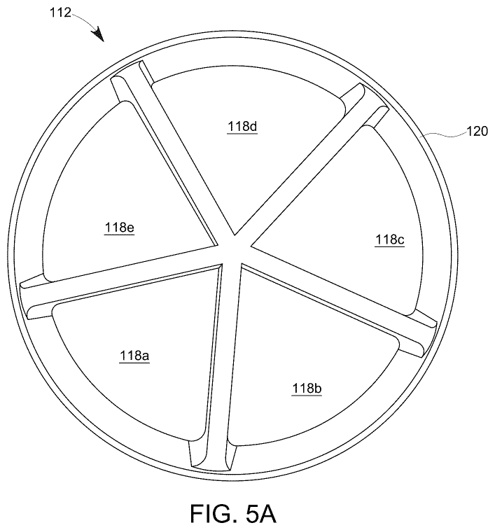

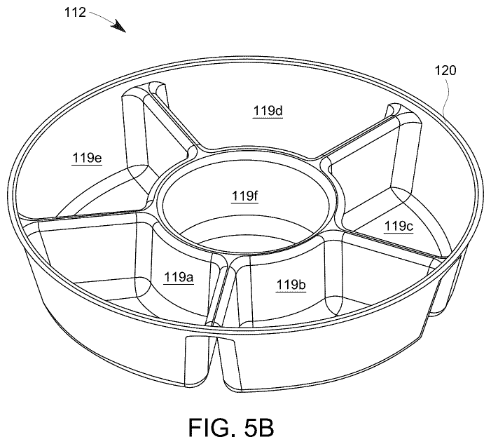

As shown in FIGS. 1, 3, 4, 9, 10, 11, and 13, the upper portion 114 may define one or more apertures 106. For example, the illustrated embodiments of the upper portion 114 define an aperture 106, although an upper portion 114 defining more than an aperture 106 (e.g., 1-2 apertures, 1-5 apertures, etc.) are also contemplated herein. With the upper portion 114 operatively coupled to the storage portion 112, the upper portion 114 may rotate with respect to the storage portion 112 (i.e., relative to the storage portion). Rotation of the upper portion 114 relative to the storage portion 112 may be approximately about the centroid 111 of the upper portion 114 when view from a perspective normal to the cutting surface 102 (shown in FIG. 4). When the upper portion 114 is made to rotate, the aperture 106 may be aligned (i.e., substantially aligned) with a compartment 118 of the one or compartments of the storage portion (e.g., compartments 118a, 118b, 118c, 118d, 118e of FIG. 5A, or compartments 119a, 119b, 119c, 119d, 119e of FIG. 5B). When, for example, the aperture 106 is aligned with a compartment 119a of the storage portion 112 (shown in FIG. 5B); food processed on the cutting surface 102 of the upper portion 114 may be transferred from the cutting surface 102, through the aperture 106, and into the compartment 119a. The upper portion 114 may then be rotated to align the aperture 106 with a compartment 119b, and food processed on the cutting surface 102 of the upper portion 114 may be transferred from the cutting surface 102, through the aperture 106, and into the compartment 119b. The described process of processing, organizing, and storing food may be repeated for any compartment 119a, 119b, 119c, 119d, 119e, and in any order. Alternative embodiments may include more than one aperture defined by the upper portion 114 and may include the capability of aligning more than one aperture with more than one compartment with a multitude of configurations and configurations therebetween achieved by the rotation of the upper portion 114. In embodiments where the storage portion 112 includes a large compartment, rotation of the upper portion 114 relative to the storage portion 112 may distribute processed food throughout the compartment instead of in individual compartments.

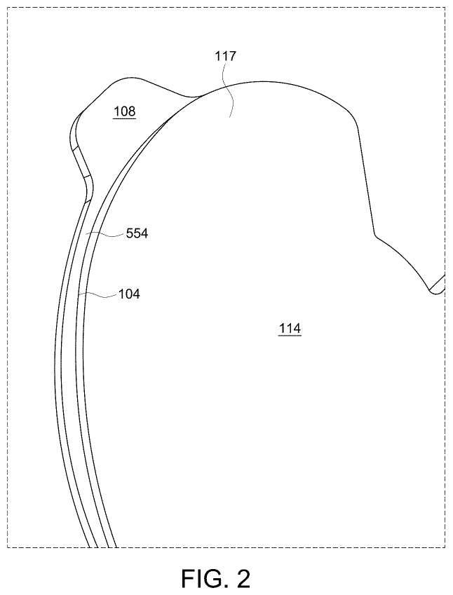

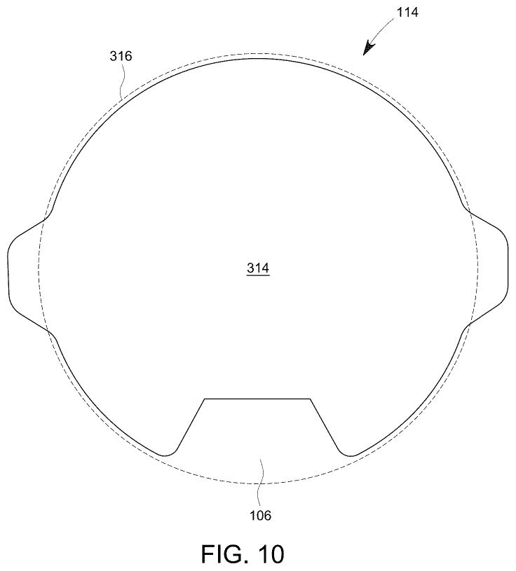

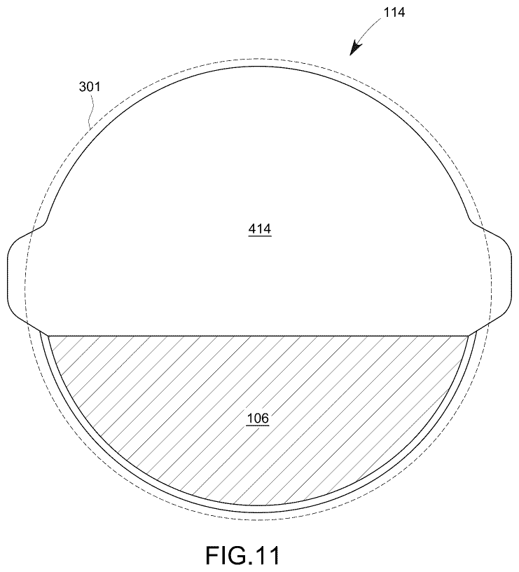

The upper portions described herein may utilize rotational interfaces for the rotation of the upper portion 114 with respect to the storage portion 112. An embodiment of a rotational interface is illustrated in FIGS. 2 and 9. FIG. 9 shows a rim 120 of the storage portion 112. The rim 120 is a circular portion of the storage portion 112 extending above the compartment height 502 of the one or more compartments 119 by rim height 504. The upper portion 114 includes a bottom surface 117, which may define a shelf 104 (shown in FIG. 2). As shown in FIG. 9, the bottom surface 117 of the upper portion 114 includes a first diameter 350 that is larger (e.g., by about 0.5 cm to about 2.5 cm; by about 0.75 cm to 2.0 cm; by about 1.0 cm to about 1.5 cm; etc.) than a second diameter 352 of a protruding portion 351 of the upper portion 114 nearest the storage portion 112 (shown in FIG. 9). As such, the circumference 316 (shown in FIGS. 10 and 11) of the cutting surface 102 of the upper portion 114 may be larger (e.g., by about 1.5 cm to about 8 cm; by about 2.5 cm to about 6.5 cm; by about 3.0 cm to about 4.5 cm; etc.) than the circumference of the protruding portion 351. The second diameter 352 is less than the inner diameter 358 of the rim 120 of storage portion 112, while the first diameter 350 is greater than the inner diameter 358 of the rim 120. The ratio of second diameter 352 to the inner diameter 358 of the rim 120 is about 80% to about 99%; about 85% to 98%; about 90% to about 97%; etc. As such, the portion of the upper portion 114 with second diameter 352 fits within the rim 120 and is held approximately concentric with the rim 120. In addition, with the first diameter 350 being greater than the inner diameter 358 of the rim 120, the portion 554 of the shelf 104 (shown in FIG. 2) rests on the rim 120 (shown in FIG. 9). Interfaced as such, the upper portion 114 of the device 300 is capable of rotating with respect to the storage portion 112 as described above by the shelf 104 defined by the bottom surface 117 of the upper portion 114. The first rotational interface embodiment is capable of interfacing with the rim of FIGS. 5A, 5B, 7, and 9. Although a shelf 104 is shown as the rotational interface between the upper portion and the storage portion, one of skill in the art may appreciate that shelf 104 may be replaced with a track or a groove such that the rim 120 of the storage portion 112 tracks or rotates within the track or groove.

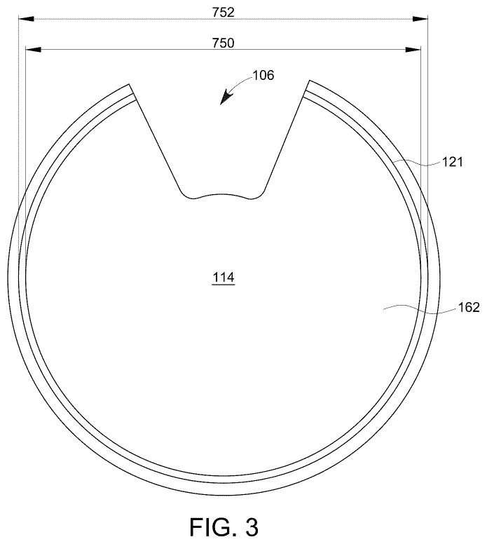

Shown in FIG. 3, another embodiment of a rotational interface includes an upper portion 114 with a bottom face 162 including a recessed ring 121. The recessed ring 121 is circular minus any portion within an aperture 106 or apertures defined by the upper portion 114. The inner diameter 752 of the recessed ring 121 is less than the inner diameter 358 of the rim 120 (shown in FIG. 9). The ratio of inner diameter 752 of the recessed ring 121 to the inner diameter 358 of the rim 120 is about 80% to about 99%; about 85% to 98%; about 90% to about 97%; etc. The outer diameter 750 of the recessed ring 121 is greater than the outer diameter 360 (shown in FIG. 9) of the rim 120. The ratio of the outer diameter 360 of the rim 120 to the outer diameter 750 of the recessed ring 121 is about 80% to about 99%; about 85% to 98%; about 90% to about 97%; etc. As such, at least a portion of the rim 120 (shown in FIG. 9) fits within the recessed ring 121 (shown in FIG. 2). Interfaced as such, the upper portion 114 is capable of rotating with respect to the storage portion 112 as described above. The second rotational interface embodiment is capable of interfacing with, including but not limited to, the rim of FIGS. 5A, 5B, 7, and 9.

Shown in FIG. 8, another embodiment of a rotational interface includes an upper portion 114 with a protruding portion 251 including a second diameter 250 less than a first diameter 254. The described upper portion 114 can interface with a storage portion 112 similar to or alike those shown in FIGS. 5B and 8. The storage portion 112 may include a centralized compartment 119f. The compartment 119f may include a circular shape and may be concentrically aligned with the circular shape of the rim 120. The portion of the upper portion 114 with a second diameter 250 may fit within the inner diameter 252 of the compartment 119f. The ratio of the second diameter 250 to the inner diameter 252 of the compartment 119f is about 80% to about 99%; about 85% to 98%; about 90% to about 97%; etc. Interfaced as such, the upper portion 114 is capable of rotating with respect to the storage portion 112 as described above. The various embodiments of rotational interfaces provide stable and ergonomic control for the rotation of the upper portion with respect to the storage portion. Further, this may be facilitated by the inclusion of one or more handles 108 (shown in FIGS. 1 and 2). The one or more handles 108 are formed from or coupled to the upper portion 114 and extend beyond the outer diameter 360 of the rim 120 (shown in FIG. 9). As such, the one or more handles provide a feature or features for a user to grip and position the components. The one or more handles 108 provide increased leverage about the point of rotation for the upper portion 114 (e.g., the centroid 111 of FIG. 4).

It has been contemplated that any embodiment described herein may utilize an upper portion 114 with a bottom face 162 (shown in FIG. 9) in contact or near contact with the top of the compartments 118 or compartments 119. The bottom face 162 may be at a height 503 equal to height 502 or greater than height 502 by about 0.5 mm to about 6 mm; about 1 mm to about 5 mm; about 1.5 mm to about 4 mm; about 2 mm to about 3.5 mm; about 2.5 mm to about 3 mm; etc. As such, when force is applied to the upper portion 114, e.g., during processing food, the force may deflect the device, such that the upper portion 114 contacts the top of the compartments 118 or compartments 119, evenly distributing the force about the storage portion 112. Evenly distributing the force about the storage portion 112 increases the amount of load that may be supported by the device 300.

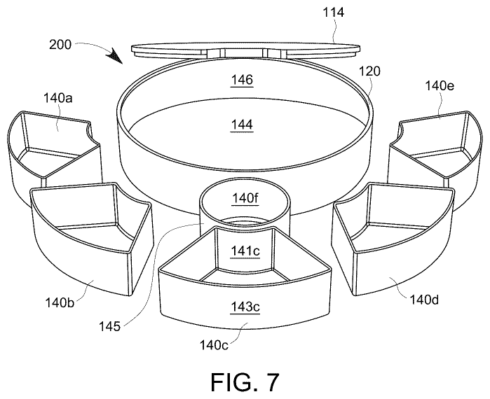

The storage portions described herein may include one or more compartments (e.g., 118a, 118b, 118c, 118d, and/or 118e (shown in FIG. 5A), or one or more compartments 119a, 119b, 119c, 119d, 119e, and/or 119f (shown in FIG. 5B)). Storage portions described herein may be extruded from a single piece of material (e.g., metal, plastic, etc.) or may be an assembly of a plurality of pieces. For example, FIG. 7 shows a device 200 embodiment with removable compartments 140a, 140b, 140c, 140d, 140e, 140f contained by the storage portion 144. Removable compartments 140a, 140b, 140c, 140d, 140e, 140f may be placed within or removed from a storage portion 144. For example, each of the removable compartments may be sized and/or shaped such that they fit or are assembled in the storage portion 144 in a fixed orientation. For example, a first end 141c of the removable compartment 140c may be complementary (i.e., matching in curvature) to an external circumferential surface 145 of the removable compartment 140f, while a second end 143c, opposite the first end 141c, of the removable compartment 140c may be complementary to an internal circumferential surface 146 of the storage portion 144. As such, with the storage compartments positioned in the storage portion 144, the first end 141c of the removable compartment 140c is adjacent to the external circumferential surface 145 of the removable compartment 140f, while the second end 143c of the removable compartment 140c is adjacent to the internal circumferential surface 146 of the storage portion 144. In addition, storage portions described herein may include non-slip features on the bottom surface intended for the device to rest upon. The non-slip features may include one or more standoffs constructed of material with high friction coefficients (e.g., silicon, rubbers, etc.). Non-slip features at the interface of the devices described herein and the surface they rest upon increase the stability and ergonomics of the devices.

As shown in FIG. 14, one or more of or the plurality of the compartments (e.g., compartment 119a, compartment 119b, compartment 119c, compartment 119d, compartment 119e, compartment 119f) of the storage portion 112 may be coupled together by one or more ribs (e.g., rib 601, rib 602, rib 603, rib 604, rib 605, rib 606, rib 607, rib 608, rib 609, rib 610) integrally formed on the bottom external surface 671 of the storage portion 112. For example, compartment 119a may be coupled to adjacent compartment 119b by rib 602 and compartment 119a may be coupled to adjacent compartment 119f by rib 601. For example, compartment 119b may be coupled to adjacent compartment 119c by rib 604 and compartment 119b may be coupled to adjacent compartment 119f by rib 603. For example, compartment 119c may be coupled to adjacent compartment 119d by rib 606 and compartment 119c may be coupled to adjacent compartment 119f by rib 605. For example, compartment 119d may be coupled to adjacent compartment 119e by rib 608 and compartment 119d may be coupled to adjacent compartment 119f by rib 607. For example, compartment 119e may be coupled to adjacent compartment 119a by rib 610 and compartment 119e may be coupled to adjacent compartment 119f by rib 609. Adjacent may mean a long side 651 of a compartment 119e is positioned next to or in contact with a long side 653 of a second compartment 119a, and/or a side 657 complementary to and positioned next to or in contact with an external surface 655 of a third compartment 119f. The ribs described may be coupled to each compartment approximately perpendicular to a side of each compartment or perpendicular to the tangent of a compartment (e.g., compartment 119f). Coupling the compartments (e.g., compartment 119a, compartment 119b, compartment 119c, compartment 119d, compartment 119e, compartment 119f) of the storage portion 112 with one or more ribs (e.g., rib 601, rib 602, rib 603, rib 604, rib 605, rib 606, rib 607, rib 608, rib 609, rib 610) increases the strength, rigidity, and/or stability of the storage portion 112 of the device. Ribs described herein may integrally formed with the storage portion 112 (e.g., formed during extrusion of the storage portion 112), or coupled to the compartments during assembly of the storage portion 112. Although a rib is shown between each pair of compartments, one of skill in the art will appreciate that there may be fewer ribs (e.g., not all pairs have a rib therebetween) or there may be one or more or a plurality of ribs between adjacent compartments. It is contemplated herein that two compartments of the storage portion 112 may be coupled together via one or more ribs, three compartments of the storage portion 112 may be coupled together via a plurality of ribs, four compartments of the storage portion 112 may be coupled together via a plurality of ribs, five compartments of the storage portion 112 may be coupled together via a plurality of ribs, etc.

Embodiments may include different sized apertures defined by the upper portion 114. Shown in FIG. 10, the minimum size of an aperture 106 used with embodiments described herein may be about 5% of the cutting surface 314 area. The cutting surface 314 area is found by dividing the circumference 316 of the cutting surface 314 by 2*Pi for a first value, squaring the first value to get a second value, and then multiplying the second value by Pi to get the area of the cutting surface 314. As such, an aperture defined by the upper portion of a device is greater than or equal to about 5% of the area within the circumference 316 of the cutting surface 314. Shown in FIG. 11, the maximum size of an aperture 106 used with embodiments described herein may be about 45% of the cutting surface 414 area. The cutting surface 414 area is found by dividing the circumference 301 of the cutting surface 414 by 2*Pi for a first value, squaring the first value to get a second value, and then multiplying the second value by Pi to get the area of the cutting surface 414. As such, an aperture defined by the upper portion of a device are less than or equal to about 45% of the area within the circumference 316 of the cutting surface 314. As such, the upper portion may define an aperture of about 5% to about 50% of the cutting surface of the upper portion. In some embodiments, the upper portion is greater than about a semi-circle or half-circle. In some embodiments, the upper portion is greater than about a three-quarter circle.

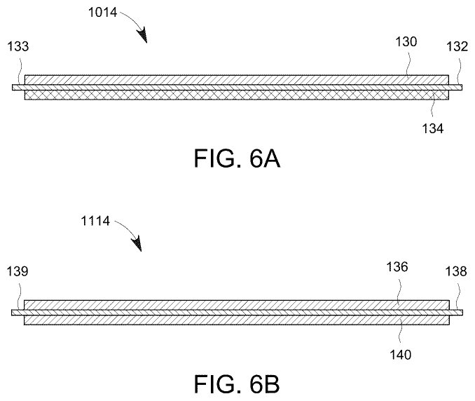

As shown in FIGS. 6A and 6B, the upper portion 1014, 1114 may be include composites or layers 130, 132, 134 of dissimilar materials (e.g., metal, plastic, wood, etc.). In addition, the upper portion 1014, 1114 may include one or more elements to interface (e.g., any of the rotational interface embodiments described herein) with a storage portion on opposite sides. As such, the upper portion may interface with the storage portion in a first orientation or flipped 180-degrees in a second orientation. As shown in FIG. 6A, the upper portion 1014 may include a first layer 130 of material (e.g., plastic, wood, metal, glass, etc.), a second layer 132 of material (e.g., plastic, wood, metal, glass, etc.), and the third layer 134 of material (e.g., plastic, wood, metal, glass, etc.). In some embodiments, the first layer 130 may be bonded to the second layer 132 on a first side of the second layer 132 and the third layer 134 may be bonded to the second layer 132 on a second side of the second layer 132, the second side being opposite the first side. As such, the upper portion 1014 may include a different cutting surface material for each orientation (e.g., first orientation, or second orientation). FIG. 6B shows an upper portion 1114 with a first layer 136 and a third layer 140 constructed of similar materials (e.g., wood, metal, plastic, etc.). The second layer 138 may include a dissimilar material (e.g., wood, metal, plastic, etc.) from the first layer 136 and third layer 140. In addition, the second layer 132 of upper portion 1014 (shown in FIG. 6A) may include at least a portion 133 that extends past (forms an overhang) the first layer 130 and the third layer 134. Further, the second layer 138 of the upper portion 1114 may include at least a portion 139 that extends past (forms an overhang) the first layer 136 and the third layer 140. In embodiments with at least a portion of the second layer extending beyond the first layer and the third layer, the portion (e.g., portion 133 in FIG. 6A, portion 139 in FIG. 6B, etc.) may form a handle (e.g., handle 108 in FIG. 2) or multiple handles, and/or may form the top portion 554 of the shelf 104 (shown in FIG. 2) to rest on the rim 120 (shown in FIG. 9). The three layers constructing the upper portion 1014 of FIG. 6A and the upper portion 1114 of FIG. 6B may be coupled together by any elements or methods known in the art (e.g., nails, screws, adhesives, etc.). Alternatively, any one or more of the upper portion, storage portion, optional lid, or one or more compartments may be formed by additive manufacturing methods.

As mentioned above and shown in FIG. 12, the device may include a lid 110 for the concealment and securement of contents within the compartments of the storage portion 112. The lid 110 may be reversibly positionable between the upper portion and the storage portion and couplable to the upper portion and the storage portion. It may be desirable to position or couple the lid 110 within the device between the upper portion 114 and the storage portion 112 to block the communication of the aperture 106 with one or more compartments 119 (shown in FIG. 13). As such, contents within the one or more compartments 119 may not be allowed to exit the device 400 and can be concealed by the lid 110 if the lid 110 were to be formed from a non-transparent material (e.g., non-transparent plastic, rubber, metal, etc.). Forming the lid 110 from a transparent material has been contemplated herein, for example, a transparent plastic. The lid 110 may include a material that is, at least, somewhat elastic (e.g., a plastic, rubber, etc.). The lid 110 may be formed to fit in the tolerance between the storage portion 112 and the upper portion 114. As such, some embodiments may include a lid 110 that is compressed by the upper portion 114 when coupled with the storage portion 112 and, by doing so, the upper portion 114 and lid 110 may be held in the assembly by the compressive force and friction of the lid 110 (e.g., formed from rubber) compressed in the tolerance between the upper portion 114 and the storage portion 112. As shown in FIG. 12, the lid 110 may include an external surface 705, opposite an internal surface 703, and a rim portion 707. The lid 110 is positionable between the upper portion 114 and the storage portion 112 with the external surface next to, or in contact with, the upper portion 114 and the internal surface 703 next to, or in contact with, the storage portion 112. The lid 110 is positionable such that the rim portion 707 is complementary to the storage portion 112 rim 120 and the shelf 104 of the upper portion 114. As such, the lid 110 may fit, or be forced (e.g., compressed), within the tolerance between the storage portion 112 and the upper portion 114.

### Methods

A method of using a device for processing and storing food is contemplated herein. The method includes using a device for processing and storing food. Using a device for processing and storing food includes processing food on a cutting surface of an upper portion of the device, the upper portion being rotatably and reversibly coupled to a storage portion of the device. The method further includes rotating the upper portion of the device with respect to the storage portion of the device to align an aperture defined by the upper portion of the device with a first compartment of one or more compartments either defined by or contained by the storage portion of the device. The method further includes transferring food processed on the cutting surface of the upper portion of the device through the aperture defined by the upper portion of the device and into the first compartment of the one or more compartments. Some embodiments of the method may include removing the upper portion of the device from the storage portion of the device to access the food contained by the first compartment of the one or more compartments. Some embodiments of the method may include reversibly positioning a lid between the upper portion of the device and the storage portion of the device to limit access to the food contained by the storage portion. In some embodiments, the lid is couplable between the upper portion and the storage portion. In some embodiments, the lid is configured to block communication between the aperture and the first compartment when positioned between the upper portion and the storage portion.

References in the specification to “one embodiment,” “an embodiment,” “an illustrative embodiment,” “some embodiments,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

As used in the description and claims, the singular form “a”, “an” and “the” include both singular and plural references unless the context clearly dictates otherwise. For example, the term “compartments” may include, and is contemplated to include, a plurality of compartments. At times, the claims and disclosure may include terms such as “a plurality,” “one or more,” or “at least one;” however, the absence of such terms is not intended to mean, and should not be interpreted to mean, that a plurality is not conceived.

The term “about” or “approximately,” when used before a numerical designation or range (e.g., to define a length), indicates approximations which may vary by (+) or (−) 5%, 1% or 0.1%. All numerical ranges provided herein are inclusive of the stated start and end numbers. The term “substantially” indicates mostly (i.e., greater than 50%) or essentially all of a device, substance, or composition.

As used herein, the term “comprising” or “comprises” is intended to mean that the devices, systems, and methods include the recited elements, and may additionally include any other elements. “Consisting essentially of” shall mean that the devices, systems, and methods include the recited elements and exclude other elements of essential significance to the combination for the stated purpose. Thus, a system or method consisting essentially of the elements as defined herein would not exclude other materials, features, or steps that do not materially affect the basic and novel characteristic(s) of the claimed disclosure. “Consisting of” shall mean that the devices, systems, and methods include the recited elements and exclude anything more than a trivial or inconsequential element or step. Embodiments defined by each of these transitional terms are within the scope of this disclosure.

The examples and illustrations included herein show, by way of illustration and not of limitation, specific embodiments in which the subject matter may be practiced. Other embodiments may be utilized and derived therefrom, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

### EXAMPLE EMBODIMENTS

Example 1. A device for processing and storing food, comprising: a storage portion; an upper portion defining an aperture, the upper portion being configured to be rotatably and reversibly couplable to the storage portion; and a plurality of compartments either defined by the storage portion or contained by the storage portion, wherein the upper portion includes a cutting surface, wherein the upper portion is configured to rotate with respect to the storage portion to substantially align the aperture with a first compartment of the plurality of compartments.

Example 2. The device of any one of the preceding examples, but particularly example 1, further comprising a lid reversibly positionable between the upper portion and the storage portion and couplable to the upper portion and the storage portion, wherein the lid is configured to block communication between the aperture and any one of the plurality of compartments when positioned between the upper portion and the storage portion.

Example 3. The device of any one of the preceding examples, but particularly example 1, wherein the upper portion comprises a bottom surface opposite the cutting surface, wherein at least a portion of the bottom surface comprises a rotational interface configured to couple the upper portion to the storage portion.

Example 4. The device of any one of the preceding examples, but particularly example 1, further comprising one or more ribs configured to couple two or more compartments of the plurality of compartments together.

Example 5. The device of any one of the preceding examples, but particularly example 4, wherein the two or more compartments are adjacent to each other.

Example 6. A device for processing and storing food, comprising: a storage portion defining at least a first compartment; and an upper portion defining an aperture, wherein a bottom surface of the upper portion is configured to be rotatably and reversibly coupled to the storage portion, wherein the upper portion is configured to be rotated relative to the storage portion, wherein the upper portion includes a cutting surface, opposite the bottom surface.

Example 7. The device of any one of the preceding examples, but particularly example 6, wherein the upper portion is configured to be rotated relative to the storage portion to substantially align the aperture with the first compartment.

Example 8. The device of any one of the preceding examples, but particularly example 6, further comprising a lid reversibly positionable between the upper portion and the storage portion and couplable to the upper portion and the storage portion, wherein the lid is configured to block communication between the aperture and the first compartment when positioned between the upper portion and the storage portion.

Example 9. The device of any one of the preceding examples, but particularly example 6, wherein the upper portion comprises a bottom surface opposite the cutting surface, wherein at least a portion of the bottom surface comprises a rotational interface configured to couple the upper portion to the storage portion.

Example 10. The device of any one of the preceding examples, but particularly example 6, wherein the storage portion defines a plurality of compartments, each compartment of the plurality of compartments being alternatively alignable with the aperture defined by the upper portion.

Example 11. The device of any one of the preceding examples, but particularly example 10, further comprising one or more ribs configured to couple two or more compartments of the plurality of compartments together.

Example 12. The device of any one of the preceding examples, but particularly example 11, wherein the two or more compartments are adjacent to each other.

Example 13. A method of using a device for processing and storing food, comprising: processing food on a cutting surface of an upper portion of the device, the upper portion being rotatably and reversibly coupled to a storage portion of the device; rotating the upper portion of the device with respect to the storage portion of the device to align an aperture defined by the upper portion of the device with a first compartment of one or more compartments either defined by or contained within the storage portion of the device; and transferring at least a portion of the processed food on the cutting surface of the upper portion of the device through the aperture defined by the upper portion of the device and into the first compartment of the one or more compartments.

Example 14. The method of any one of the preceding examples, but particularly example 13, further comprising removing the upper portion of the device from the storage portion of the device to access the at least a portion of the processed food contained by the first compartment of the one or more compartments.

Example 15. The method of any one of the preceding examples, but particularly example 13, further comprising reversibly positioning a lid between the upper portion of the device and the storage portion of the device, wherein the lid is couplable to the upper portion and the storage portion, and wherein the lid is configured to block communication between the aperture and the first compartment when positioned between the upper portion and the storage portion.

What is claimed is:

1. A device for processing and storing food, comprising:
a storage portion;
an upper portion defining an aperture, the upper portion being configured to be rotatably and reversibly couplable to the storage portion;
a plurality of compartments either defined by the storage portion or contained by the storage portion; and
one or more ribs configured to couple two or more compartments of the plurality of compartments together at a bottom external surface of the storage portion,
wherein the upper portion includes a cutting surface,
wherein the upper portion is configured to rotate with respect to the storage portion to substantially align the aperture with a first compartment of the plurality of compartments.

2. The device of claim 1, further comprising a lid reversibly positionable between the upper portion and the storage portion and couplable to the upper portion and the storage portion, wherein the lid is configured to block communication between the aperture and any one of the plurality of compartments when positioned between the upper portion and the storage portion.

3. The device of claim 1, wherein the upper portion comprises a bottom surface opposite the cutting surface, wherein at least a portion of the bottom surface comprises a rotational interface configured to couple the upper portion to the storage portion.

4. The device of claim 1, wherein a rib of the one or more ribs is approximately perpendicular to a side of each compartment.

5. The device of claim 4, wherein the two or more compartments are adjacent to each other.

6. The device of claim 1, wherein a bottom surface of the upper portion is in contact or near contact with a top of the plurality of compartments to distribute a force applied to the cutting surface.

7. The device of claim 1, wherein the aperture defined by the upper portion of the device is greater than or equal to about 5% of an area within a circumference of the cutting surface.

8. A device for processing and storing food, comprising:
a storage portion;
at least a first compartment configured to be removably positioned in the storage portion; and
an upper portion defining an aperture, wherein a bottom surface of the upper portion is configured to be rotatably and reversibly coupled to the storage portion,
wherein the upper portion is configured to be rotated relative to the storage portion,
wherein the upper portion includes a cutting surface, opposite the bottom surface.

9. The device of claim 8, wherein the upper portion is configured to be rotated relative to the storage portion to substantially align the aperture with the first compartment.

10. The device of claim 8, further comprising a lid reversibly positionable between the upper portion and the storage portion and couplable to the upper portion and the storage portion, wherein the lid is configured to block communication between the aperture and the first compartment when positioned between the upper portion and the storage portion.

11. The device of claim 8, wherein the upper portion comprises a bottom surface opposite the cutting surface, wherein at least a portion of the bottom surface comprises a rotational interface configured to couple the upper portion to the storage portion.

12. The device of claim 8, wherein the storage portion defines a plurality of compartments, each compartment of the plurality of compartments being removable from the storage portion.

13. The device of claim 12, further comprising one or more ribs configured to couple two or more compartments of the plurality of compartments together at a bottom external surface of the storage portion.

14. The device of claim 13, wherein a rib of the one or more ribs is approximately perpendicular to a side of each compartment.

15. The device of claim 14, wherein two or more compartments are adjacent to each other.

16. The device of claim 14, wherein a bottom surface of the upper portion is in contact or near contact with a top of the plurality of compartments to distribute a force applied to the cutting surface.

17. The device of claim 8, wherein the storage portion defines a plurality of compartments, each compartment of the plurality of compartments being alternatively alignable with the aperture defined by the upper portion.

18. The device of claim 8, wherein the aperture defined by the upper portion of the device is greater than or equal to about 5% of an area within a circumference of the cutting surface.
